(19) United States
(12) Patent Application Publication
(10) Pub. No.: US 2007/0259147 A1
(43) Pub. Date: Nov. 8, 2007

(54) Pipe

(76) Inventors: John Alexandre Boudry, Ipswich (GB); Mark Cook, Ipswich (GB)

Correspondence Address: STETINA BRUNDA GARRED & BRUCKER, 75 ENTERPRISE, SUITE 250, ALISO VIEJO, CA, 92656, US

(21) Appl. No.: 10/569,741

(22) PCT Filed: Aug. 23, 2004
(86) PCT No.: PCT/GB04/03605

§ 371 Date: Feb. 12, 2007

(30) Foreign Application Priority Data
Aug. 23, 2003 (GB) 0319911.4

(51) Int. Cl. B29D 22/00

(52) U.S. Cl. 428/36.8; 428/35.7

(57) ABSTRACT

A flexible multi-layer pipe assembly comprising, in a radial direction from the inside to the outside:—(i) an inner barrier layer formed from a first fluoropolymer; (ii) an intermediate or core layer formed from a polymer or blend of polymers; (iii) an outer barrier layer formed from a second fluoropolymer.

### FIELD OF THE INVENTION

The present invention relates to pipes suitable for the transmission of fluids. It is particularly applicable to pipes having a multi-layer structure and having very low permeability to fuels such as petroleum and to the various additives used in such fuels.

While the invention is particularly applicable to double walled pipe assemblies used in the petroleum, chemical and natural gas industries, it should be appreciated that such a pipe assembly can be utilized in connection with any type of installation in which leakage of a hazardous fluid, be it a liquid, a gas or a vapour, into the surrounding environment over long periods of time and without detection will produce extensive pollution and an environmental hazard. Such pollution is likely to be difficult and expensive to clean up when it is ultimately found.

### BACKGROUND TO THE INVENTION

A conventional underground fluid piping systems such as is utilized in, e.g. a service station environment, is typically made of steel, fibreglass or plastic. Such systems include lengths of pipe together with T-fittings, elbows, connector fittings, union fittings and the like. The assembly of these components creates a fluid piping system with many joints and typically a layout design that has many turns in congested plumbing areas. Since the primary source of leaks is at the joints and fittings of a system, such systems are prone to leakage. In addition, the many fittings are adversely affected by ground movement during the life of the fluid system as well as by improper installation and environmental degradation such as corrosion.

In response to environmental regulations and ever stricter pollution control requirements at the federal, state and local levels, strict regulations have been implemented for underground piping that transmits hazardous fluids. Equipment manufacturers have responded by developing a variety of secondary containment systems for conventional underground piping. Such containment systems are designed to prevent the fluid that may leak from the inner pipe or hose from escaping into the environment. Typically, the pipes forming the secondary containment pipeline are initially separate from the fuel pipes and are sleeved over the latter as the fuel pipes are installed between the fuel storage tanks and dispensing pumps. This provides an interstitial gap between the primary and secondary pipe, which temporarily stores any leaked fuel from the primary, until it is detected and repaired. This interstitial space may also be vented and connected to a detection system. This provides an early indication that there has been a release of fuel from the primary pipe and may also provide an audible warning to the operator of the site.

Oil companies remain under considerable pressure to ensure that environmental concerns are given priority in the planning and installation of petrol/service station infrastructures. This has not been without significant on-cost. One important advancement has been the use of pipeline systems constructed from plastics materials which have enabled the oil companies to install cost-effective environmentally acceptable alternatives to steel pipework systems which tend to corrode over time.

However, there remains great public concern because chemicals are still penetrating into underground water supplies and vapours diffusing into sub-surface soil, contaminating public drinking water and making some of the food supply unusable, amongst other things. The most notable chemicals within the oil industry are benzene, toluene, ethylbenzene and xylene, denoted as BTEX. According to some, the entire environment is being downgraded to a serious level which tends to cast doubt on the future availability of safe water. This problem is exacerbated by the fact that all pipe manufactured from plastics material, as opposed to metal, is permeable to some extent to small organic molecules such as the hydrocarbons, alcohols and additives typically found in modern fuels.

Manufacturers have responded by, amongst other things, introducing a permeation resistant or barrier layer within the pipe consisting of a material that is less permeable to the fluid being carried than the body of the pipe itself. The art contains many examples of such multi-layer pipe assemblies, for example EP 0 534 588 (Teleflex Inc) and EP 1 053 866 (Hsich). Alternatively, the entire pipe can be formed from the permeation resistant material.

However, there are still drawbacks with these solutions. In the case of forming the entire pipe from a permeation resistant material such as polyvinylidene fluoride (PVDF), this tends to be prohibitively expensive in what is a fiercely price-competitive market. Furthermore the tensile strength and other physical properties of this type of material are not ideal for forming a pipe of this type. Such materials tend to be too rigid or do not have sufficient mechanical strength, or both.

In the case of multi-layer pipes, those in the prior art do not have permeation properties that meet project regulatory requirements.

It is therefore an object of the present invention to overcome or mitigate some or all of the problems outlined above.

### SUMMARY OF THE INVENTION

According to a preferred aspect of the present invention there is provided a flexible multi-layer pipe assembly comprising, in a radial direction from the inside to the outside:—
i) an inner barrier layer formed from a first fluoropolymer;
ii) an intermediate or core layer formed from a polymer or blend of polymers;
iii) an outer barrier layer formed from a second fluoropolymer.

This construction has the advantage that the rate of permeation of fluids out of or into the pipe is greatly reduced over prior art multi-layer pipes whilst the pipe assembly is still cost effective to manufacture.

Preferably the first and second fluoropolymer layers comprise a plastics material selected from the group comprising:—
polyvinylidene fluoride (PVDF) and copolymers;
polyvinyl fluoride (PVF);
tetrafluoroethylene-ethylene copolymer (ETFE);
tetrafluoroethylene-hexafluroethylene copolymers (FEP)
ethylene tetrafluoroethylene hexafluropropylene terpolymers (EFEP)
terpolymers of tetrafluoroethylene, hexafluoropropylene and vinylidene fluoride (THV);
polyhexafluoropropylene;
polytetrafluoroethylene (PTFE);
polychlorotrifluoroethylene;
polychlorotrifluoroethylene (PCTFE);
fluorinated polyethylene;
fluorinated polypropylene,
and blends and co-polymers thereof.

This selection is not intended to be limiting but rather demonstrates the flexibility and breadth of the invention. The plastics material with the lowest permeability to the fluid in question will usually be chosen by the materials specialist. Furthermore, it is known to use blends of two or more polymers and this invention extends to cover known and yet to be developed blends of plastics material.

Preferably, the intermediate or core layer comprises a plastics material selected from the group comprising:—
polyethylene;
polypropylene;
polyvinyl chloride;
polybutylene
polyurethanes;
polyamides, including polyamides 6, 6.6, 6.10, 6.12, 11 and 12;
polyethylene terphthalate;
polybutylene terephthalate;
polyphenylene sulphide;
polyoxymethylene (acetal)
ethylene/vinyl alcohol copolymers,
including blends and co-polymers thereof.

Once again, this selection is not intended to be limiting. The most appropriate polymer or blend of polymers will be selected by the materials specialist.

Particularly preferred materials for the intermediate layer are polythene and the polyamides 11 or 12.

Preferably the outer barrier layer is an electrofusible polymer. This enables the pipe assembly to be joined using proven electrofusion coupling techniques.

Preferably the first fluoropolymer of the inner barrier layer incorporates a dispersed electrically conductive material producing a maximum surface resistivity of 10⁶ Ω/sq. This avoids build up of potentially dangerous static electrical charges. A surface resistivity in the range 10² to 10⁶ Ω/sq is preferred, with a more preferred surface resistivity in the range 10² to 10⁵ Ω/sq.

Preferably the electrically conductive material is carbon black.

In an alternative embodiment the electrically conductive material comprises finely powdered metallic fibres such as silver, copper or steel, or nanocomposites such as carbon nanotubes.

This selection is not intended to be limiting, but rather demonstrates the wide range of electrically conductive materials which may be used for this purpose.

In a particularly preferred embodiment the assembly incorporates one or more tie or adhesive layer between adjacent layers (i) and (ii) and/or (ii) and (iii). Alternatively direct bonding may be used to adhere the individual layers, preferably during melt processing, whereby one or both of the materials have been chemically modified to bond to the other.

Preferably the permeability of the pipe assembly to the fluid contained within the pipe is in the range 0 to 1 gms/m²/day.

In a particularly preferred embodiment the permeability is in the range 0 to 0.1 gms/m²/day. This permeability meets or exceeds any legislative requirements current in place anywhere in the world.

### BRIEF DESCRIPTION OF THE DRAWINGS

The present invention will now be described by way of example only, with reference to the accompanying drawings wherein:—

FIG. 1 shows a cross-sectional view of a pipe assembly according to the present invention;

FIG. 2 shows two pipe assemblies nested one within another in a primary and secondary configuration.

### DESCRIPTION OF THE PREFERRED EMBODIMENTS

Embodiments of the present invention will now be described by way of example only. They are currently the best ways known to the applicant of putting the invention into practice but they are not the only ways in which this can be achieved.

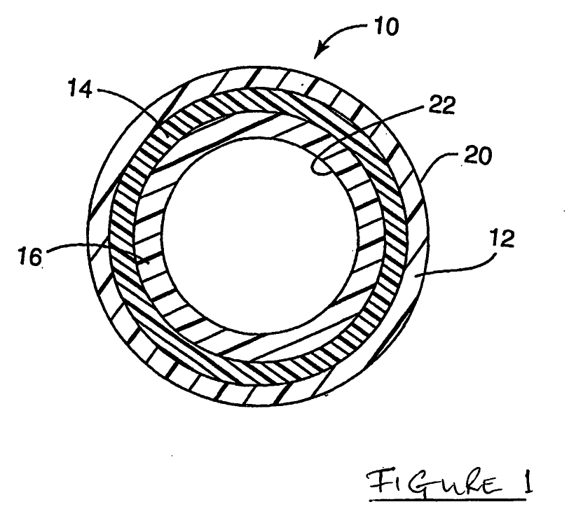

FIG. 1 illustrates a cross-sectional view of a pipe assembly 10, consisting of, working in a radial direction from the inside of the pipe assembly to the outside, an inner, barrier layer 16, an intermediate or core layer 14 and an outer barrier layer 12.

The purpose of the two barrier layers, which are formed from a plastics material which is virtually impermeable to the fluid being carried in the pipe, is to prevent or minimise the permeation of fluid out of or into the pipe and to provide good chemical resistance, both from the fluid within the pipe and from any chemical encountered on the outside of the pipe. By way of example, where the pipe assembly is designed to carry petroleum fuels, the inner barrier layer is formed from a fluoropolymer. There is a wide range of known fluoropolymers with the desired permeability characteristics. It is intended that this disclosure and this invention encompasses all fluoropolymers, known or yet to be discovered, with a permeability to hydrocarbon test fuels (e.g. fuel C), alcohols (e.g. methanol or ethanol) or blends of hydrocarbon and alcohols including additives such as methytertiarybutyl ether (MTBE) at 23±4° C. of less than 0.1 grams/m²/per day.

Examples of suitable fluoropolymers include:—
polyvinylidene fluoride (PVDF) and copolymers;
polyvinyl fluoride (PVF);
tetrafluoroethylene-ethylene copolymer (ETFE);
tetrafluoroethylene-hexafluroethylene copolymers (FEP)
ethylene tetrafluoroethylene hexafluropropylene terpolymers (EFEP)
terpolymers of tetrafluoroethylene, hexafluoropropylene and vinylidene fluoride (THV);
polyhexafluoropropylene;
polytetrafluoroethylene (PTFE);
polychlorotrifluoroethylene;
polychlorotrifluoroethylene (PCTFE);
fluorinated polyethylene;
fluorinated polypropylene,
and blends and co-polymers thereof.

This selection is not intended to be limiting, but rather demonstrates the wide range of fluoropolymers that may be used for this purpose. It is intended that this disclosure encompasses all known fluoropolymers providing a suitable barrier function and those yet to be discovered.

By way of further example, various fluoropolymers and compositions to bond them are described in WO 00/52084 (3M Innovative Properties Company), the entire text of which is incorporated by reference and which is intended to form an integral part of this disclosure.

As set out in WO 00/52084, fluoropolymer materials useful in the present invention include those fluoropolymers broadly categorized structurally into three basic classes. A first class includes those fluorinated polymers, copolymers, terpolymers, etc., comprising interpolymerized units derived from vinylidene fluoride or vinyl fluoride (sometimes referred to as “VF₂” or “VDF” and VF respectively). Preferably fluoropolymer materials of this first class comprise at least 3 percent by weight of interpolymerized units derived from VF₂ or VF. Such polymers may be homopolymers of VF₂ or VF or copolymers of VF₂ or VF and other ethylenically unsaturated monomers. Copolymers of VF₂ or VF and other ethylenically unsaturated monomers are examples of fluoropolymers.

VF₂ and VF-containing polymers and copolymers can be made by well-known conventional means, for example, by free-radical polymerization of VF₂ with or without other ethylenically-unsaturated monomers. The preparation of colloidal aqueous dispersions of such polymers and copolymers is described, for example, in U.S. Pat. No. 4,335,238 (Moore et al.). It follows the customary process for copolymerizing fluorinated olefins in colloidal aqueous dispersions, which is carried out in the presence of water soluble initiators that produce free radicals, such as, for example, ammonium or alkali metal persulfates or alkali metal permanganates, and in the presence of emulsifiers, such as, in particular, the ammonium or alkali metal salts of perfluorooctanoic acid.

Useful fluorine-containing monomers for copolymerization with VF₂ or VF include hexafluoropropylene (“HFP”), tetrafluoroethylene (“TFE”), chlorotrifluoroethylene (“CTFE”), 2-chloropentafluoro-propene, perfluoroalkyl vinyl ethers, for example, CF₃OCF═CF₂ or CF₃CF₂OCF═CF₂, 1-hydropentafluoropropene, 2-hydropentafluoropropene, dichlorodifluoroethylene, trifluoroethylene, 1,1dichlorofluoroethylene, vinyl fluoride, and perfluoro-1,3-dioxoles such as those described in U.S. Pat. No. 4,558,142 (Squire). Certain fluorine-containing di-olefins also are useful, such as perfluorodiallylether and perfluoro-1,3-butadiene. Said fluorine-containing monomer or monomers also may be copolymerized with fluorine-free terminally unsaturated olefinic co-monomers, for example, ethylene or propylene. Preferably at least 50 percent by weight of all monomers in a polymerizable mixture are fluorine-containing. Said fluorine-containing monomer may also be copolymerized with iodine-or bromine containing cure-site monomers in order to prepare peroxide curable polymer. Suitable cure-site monomers include terminally unsaturated monoolefins of 2 to 4 carbon atoms such as bromodifluoroethylene, bromotrifluoroethylene, iodotrifluoroethylene, and 4bromo-3,3,4,4-tetrafluoro-butene-1.

Commercially available fluoropolymer materials of this first class include, for example, THV 200 fluoropolymer (available from Dyneon LLC of Saint Paul, Minn.), THV 500 fluoropolymer (available from Dyneon LLC), KYNAR™ 740 fluoropolymer (available from Elf Atochem North America, Inc., Glen Rock, N.J.), and FLUOREL™ FC-2178 fluoropolymer (available from Dyneon LLC).

A second class of fluorinated material useful in the practice of the invention broadly comprises those fluorinated polymers, copolymers, terpolymers, etc., comprising interpolymerized units derived from one or more of hexafluoropropylene (“HFP”) monomers, tetrafluoroethylene (“TFE”) monomers, chlorotrifluoroethylene monomers, and/or other perhalogenated monomers and further derived from one or more hydrogen containing and/or non-fluorinated olefinically unsaturated monomers. Useful olefinically unsaturated monomers include alkylene monomers such as ethylene, propylene, 1-hydropentafluoropropene, 2-hydropentafluoropropene, etc.

Fluoropolymers of this second class can be prepared by methods known in the fluoropolymer art. Such methods include, for example, free-radical polymerization of hexafluoropropylene and/or tetrafluoroethylene monomers with non-fluorinated ethylenically-unsaturated monomers. In general, the desired olefinic monomers can be copolymerized in an aqueous colloidal dispersion in the presence of water-soluble initiators that produce free radicals such as ammonium or alkali metal persulfates or alkali metal permanganates, and in the presence of emulsifiers such as the ammonium or alkali metal salts of perfluorooctanoic acid. See, for example, U.S. Pat. No. 4,335,238 (Moore et al.).

Representative of the fluoropolymer materials of the second class are poly (ethylene-co-tetrafluoroethylene) (ETFE), poly (tetrafluoroethylene-co-propylene), poly (chlorotrifluoroethylene-co-ethylene) (ECTFE), and the terpolymer poly (ethylene-cotetrafluoroethylene-co-hexafluoropropylene), among others; all of which may be prepared by the above-described known polymerization methods. Many useful fluoropolymer materials also are available commercially, for example from Dyneon LLC, under the trade designations HOSTAFLON™ X6810, and X6820; from Daikin America, Inc., Decatur, Ala., under the trade designations NEOFLON™ EP-541, EP-521, and EP-610; from Asahi Glass Co., Charlotte, N.C., under the trade designations AFLON™ COP C55A, C55AX, C88A; and from E. I. Du Pont de Nemours and Company, Wilmington, Del., under the trade designations TEFZEL™ 230 and 290.

A third class of fluorinated materials useful in the practice of the invention broadly comprises blends of fluoropolymers and polyolefins. Specific examples include blends of PVDF and poly (methyl methacrylate) (PMMA) and blends of PVDF and high vinyl acetate functionalized polyolefins.

In a further embodiment the fluoropolymer barrier layer may take the form of a fluorinated polymer such as polythene or polypropylene or other olefinic polymer. Methods for the fluorination of polymers such as polyethylene with fluorine gas or with other fluorine-containing gases are known. A number of processes for this fluorination are known, including the use of the gas in a plasma. A procedure is described in EP 0 132 407 (MIT) using ultraviolet light to facilitate fluorination. Both batch and continuous process are possible.

Further alternative methods for fluorinating polyolefins are described in FR 2,723,100 the entire text of which is incorporated herein by reference and is intended to form an integral part of this disclosure. This document describes a method of fluorination involving exposing a pre-formed pipe to a fluorinated gas under a pressure of 1 to 500 kPa at a temperature of 20° to 100° C. The fluorinated gas may be fluorine (F₂), a rare fluorinated gas such as XeF₂, or it may be a fluorohalogen such as ClF₃, BrF₅, IF₇ or similar. The fluorinated gas may represent part of a mixture with other gases, such as oxides of sulphur, oxides of nitrogen or oxides of carbon, halogens, inter-halogen combinations, nitrogen, oxygen, ozone or mixtures of these, such as air. The proportion of the fluorinated gas may represent 0.1 to 99.9% by volume of the aforementioned mixture, usually 1 to 30% by volume, for example 10 to 20%. There is a particular preference for mixtures of gases that consist of 5 to 20% by volume of fluorinated gas such as F₂ and 5 to 95% by volume of nitrogen in the form of N₂.

Using this method, and by way of example, a pipe may be subjected to this treatment once or a plurality of times. A pipe may therefore be fluorinated 60 a desired superficial concentration, for example 30, 60, 120 or 150 μg F/cm². It is considered according to the authors that a treatment giving a superficial fluorine concentration of 30 μg F/cm² is a single treatment, that a treatment giving a superficial fluorine concentration of 60 μg F/cm² is a double treatment, that a treatment giving a superficial fluorine concentration of 120 μg F/cm² is a quadruple treatment, and that a treatment giving a superficial fluorine concentration of 150 μg F/cm² is a quintuple treatment.

By using appropriate masking techniques the inner surface only, or the outer surface only, or both inner and outer surfaces of the pipe may be fluorinated using known methods.

Further details on the fluorination of polymers can be obtained from Air Products and Chemicals, Inc., 7201 Hamilton Boulevard, Allentown, Pa. 18195-1501.

In this embodiment there is no discrete boundary between the fluoropolymer layer and the intermediate or core layer as shown in FIG. 1. Rather, the two layers will merge into each other in a diffuse manner, depending on the degree of penetration of the fluorination into the polymer layer. If, for example, the outer barrier layer is formed by the fluorination of a polymer, then the pipe would consist of an inner barrier layer formed from a fluoropolymer, a tie or adhesive layer if required, a core layer formed from substantially non-fluorinated polymer, the outer barrier layer being formed by fluorination of the external surface of the core layer.

The order of the layers would be reversed if the inner barrier layer is formed by fluorination techniques.

The intermediate or core layer may be formed from a non-fluorinated polymer such as polyethylene; polypropylene; polyvinyl chloride; polyurethanes; polyamides, including polyamides 6, 6.6, 6.10, 6.12, 11 and 12; polyethylene terphthalate; polybutylene terephthalate; polyphenylene sulphide; polyoxymethylene (acetal) ethylene/vinyl alcohol copolymers, including blends and co-polymers thereof.

Useful substantially non-fluorinated polymeric materials can thus comprise any of a number of well known hydrocarbon-based polymers, and mixtures thereof. As used herein, the term “substantially non-fluorinated” refers to polymers and polymeric materials having fewer than 10 percent of their carbon-bonded hydrogen atoms replaced with fluorine atoms. Preferably, the substantially non-fluorinated polymer has fewer than 2 percent of its carbon-bonded hydrogen atoms replaced with fluorine atoms, and more preferably fewer than 1 percent of its carbon-bonded hydrogen atoms are replaced with fluorine atoms. Preferred substantially non-fluorinated polymers include thermoplastic polyamides, polyurethanes, polyolefins, and copolymers of polyolefins.

Polyamides useful as the substantially non-fluorinated polymer are generally commercially available. For example, polyamides such as any of the well-known Nylons are available from a number of sources. Particularly preferred polyamides are nylon 6, nylon 6,6, nylon 11, or nylon 12. It should be noted that the selection of a particular polyamide material should be based upon the physical requirements of the particular application for the resulting article. For example, nylon 6 and nylon 6,6 offer higher heat resistant properties than nylon 11 or nylon 12; whereas nylon 11 and nylon 12 offer better chemical resistant properties. In addition to those polyamide materials, other nylon material such as nylon 6,12, nylon 6,9, nylon 4, nylon 4,2, nylon 4,6, nylon 7, and nylon 8 may also be used. Ring containing polyamides, for example, nylon 6, T and nylon 6, I, may also be used. Polyether containing polyamides, such as PEBAX™ polyamines, may also be used.

Polyurethane polymers useful as the substantially non-fluorinated polymer include aliphatic, cycloaliphatic, aromatic, and polycyclic polyurethanes. These polyurethanes are typically produced by reaction of a polyfunctional isocyanate with a polyol according to well-known reaction mechanisms. Useful diisocyanates for employment in the production of a polyurethane include dicyclohexylmethane-4,4′-diisocyanate, isophorone diisocyanate, 1,6-hexamethylene diisocyanate, cyclohexyl diisocyanate, diphenylmethane diisocyanate. Combinations of one or more polyfunctional isocyanates may also be used. Useful polyols include polypentyleneadipate glycol, polytetramethylene ether glycol, polyethylene glycol, polycaprolactone diol, poly-1,2-butylene oxide glycol, and combinations thereof. Chain extenders, such as butanediol or hexanediol, may also optionally be used in the reaction. Commercially available urethane polymers useful in the present invention include: PN-04 or 3429 from Morton International, Inc., Seabrook, N.H., and X-4107 from B. F. Goodrich Company, Cleveland, Ohio.

Suitable polyolefins include polyethylene, polypropylene, polyvinyl chloride, polyethylene terphthalate, polybutylene terphthalate, ethylene/vinyl alcohol copolymers including blends and co-polymers thereof.

The polymers used in the present invention may also include those containing nanocomposites. These relatively new polymers include a highly refined form of nanoclay dispersed in the plastics material. The nanoparticles can be coated to improve compatibility with the polymer component.

This technology is based on a concept whereby natural and synthetic mineral clays are modified in such a way that these can be dispersed in a polymeric matrix. The excellent adhesion between the clay layers and the polymer matrix induces remarkable improvements in material properties. The concept is as follows: the layered clay mineral is modified with a block-copolymer, of which one side is compatible with the clay, while the other matches the polymer. Via this route clay minerals can be dispersed in a wide variety of polymeric matrices by selecting the appropriate block-copolymer. A good adhesion of such modified clay particles and the polymer matrix therefore is achieved.

The resultant polymers show significantly improved performance, in particular in the areas of mechanical properties e.g. strength, modulus and dimensional stability, decreased permeability to gases, water and hydrocarbons, thermal stability and heat distortion temperature, flame retardancy and reduced smoke emissions, chemical resistance, surface appearance, electrical conductivity, and optical clarity in comparison to conventionally filled polymers.

Examples of such polymers can be obtained commercially from TNO Industry, PO Box 6235, 5600 AN Eindhoven, The Netherlands.

The above examples are not intended to be limiting and the most appropriate polymer, or blend of polymers, will be selected by the materials specialist.

In some cases the friction between petrol and the internal wall of the pipe can give rise to electrostatic charges the accumulation of which can result in an electrical discharge (spark) capable of igniting the petrol with catastrophic consequences (explosion). The surface resistivity of the inner face of the pipe must therefore be limited to a value that is generally lower than 10⁶ ohms. It is known to lower the surface resistivity of polymer resins or materials by incorporating therein conductive and/or semi conductive materials such as carbon black, steel fibres, carbon fibres or particles (fibres, platelets, spheres, etc.) which are metallized with gold, silver or nickel.

Among these materials, carbon black is commonly employed, for reasons of economy and ease of processing. Apart from its special electroconductive properties, carbon black behaves as a filler such as, for example, talc, chalk or kaolin. A person skilled in the art thus knows that, when the filler content increases, the viscosity of the polymer/filler mixture increases. Similarly, when the filler content increases, the flexural modulus of the filled polymer increases. These known and predictable phenomena are explained in the “Handbook of Fillers and Reinforcements for Plastics”, edited by H. S. Katz and J. V. Milewski, Van Nostrand Reinhold Company, ISBN 0-442-25372-9; see in particular Chapter 2, Section II for fillers in general, and Chapter 16, Section VI for carbon black in particular.

Thus it is advantageous to add between 0.1% to 10% by weight of carbon black to the fluoropolymer in the inner barrier layer, but metallic fibres such as silver, copper, steel or the like may also be used. Alternative conductive additives include nanocomposites such as carbon nanotubes.

Creating or introducing conductivity into the fluoropolymer barrier can be achieved by making the whole of the inner, barrier layer conductive. Alternatively an additional conductive layer may be formed on the inside of the inner barrier layer. This could be achieved by co-extruding a thin layer of conductive fluoropolymer on the inside of the pipe, with the remainder of the inner, barrier layer being formed from non-conductive fluoropolymer.

A typical thickness for this conductive layer in this embodiment could be in the region of 0.01 to 0.5 mm, more typically in the range 0.05 to 0.2 mm and preferably about 0.1 mm.

Where a conductive layer and a non-conductive layer are used to form the inner barrier layer these are preferably formed from the same fluoropolymer, but this need not necessarily be the case.

Many fluoropolymers do not bond or adhere effectively to the plastics materials used to form the intermediate or core layer.

Various technologies for achieving this are already known in the art. It is generally achieved in one of two ways. Either a tie layer is introduced between adjacent layers, forming in this case a 5 layer pipe, or the bulk layer or the fluorinated layers may be chemically modified such that they bond together, or possibly a combination of both technologies.

Various tie layer or adhesive technologies are described in the literature. For example an adhesive layer may be co-extruded around the inner permeation-resistant layer. The adhesive is a polymer blend or alloy that has a multi-phase morphology wherein one phase is compatible or miscible with the fluoropolymer layer, and another phase is compatible or miscible with the intermediate or core layer. Morphology development and mechanisms of phase separation in polymer alloys and blends is known and is described in the inventor's prior art publication, “Morphology and Property Control via Phase Separation or Phase Dissolution during Cure in Multiphase Systems”, Advances in Polymer Technology, Vol. 10, No. 3, pp. 185-203 (1990). The entire text of this publication is hereby incorporated by reference and intended to form an integral part of this disclosure.

A layer of non-fluorinated polymer, being an intermediate or core layer, is co-extruded around the adhesive layer. The non-fluorinated polymer may be selected from the group of polymers described above.

The process is then repeated and a further adhesive layer followed by an outer barrier layer formed from a second fluoropolymer are co-extruded or subsequently extruded around the intermediate or core layer.

Such adhesive or binder layers are described in a number of documents e.g. U.S. Pat. No. 5,934,336 (Bundy Corporation), U.S. Pat. No. 6,302,153 (Atofina), U.S. Pat. No. 5,916,945 (Elf Atochem), WO97/28394 (Bundy Corporation) and in references cited therein. These documents are herein incorporated by reference in their entirety and are intended to become an integral part of this disclosure.

An alternative method for forming a bond between two otherwise incompatible polymers involves chemically grafting some functional group or groups into or onto one or other of the polymers, or both. The grafting of some functionality onto the backbone of the polymer may be done prior to, during or post polymerisation. Such grafting technology is known per se and examples are described in WO01/81077 (Asahi Glass Company Ltd), and U.S. Pat. No. 5,958,532 (Pilot Industries Inc). Once again, the entire text of these publications is incorporated by reference and intended to form an integral part of this disclosure.

It will be appreciated that the foregoing are just some examples of adhesive layer technology and of ways of chemically modifying one polymer such that it bonds to another. It is intended that this disclosure includes all such technologies, known or yet to be discovered.

Any of the polymer layers described above can be foamed. The foaming of polymers is caused by adding a blowing agent into the polymer. Examples of such blowing agents include but are not limited to azodicarbonamides, hydrazine derivatives, semicarbazides, tetrazoles, benzoxazines and mixtures thereof. The blowing agent is mixed with the polymer just prior to the extrusion process. Following the extrusion of the outer-layer, the blowing agent will cause the polymer to expand or foam, hence creating void spaces within the layer. A number of blowing agents are already known and a variety of such agents are commercially available. A review of chemical blowing agents can be found in “Plastic Additives” by R Gachter and H Muller 4^{th} Edition, published by Hanser Gardner Publications. The entire text of that review is hereby incorporated by reference and is intended to form an integral part of this disclosure. It is intended that this disclosure and this invention encompasses all blowing agents, known and yet to be discovered.

The quantity of foaming agent added will depend on the degree of foaming required. It could be that only a very small amount of foaming agent is used, but it should be clear that this disclosure is intended to encompass both foamed and unfoamed plastics materials.

In order that sections of pipe may be joined together a variety of couplings will be required. It is particularly preferred if these couplings are of the electrofusion type. It is therefore also particularly preferred that the outer barrier layer is of a composition, and of a suitable thickness, to undergo electrofusion. For example, the outer barrier layer may be formed from polyvinylidene fluoride and have a thickness in the range of 1 mm to 10 mm, more preferably in the range 2 mm to 5 mm. Other suitable electrofusible fluoropolymers will be selected by the materials specialist.

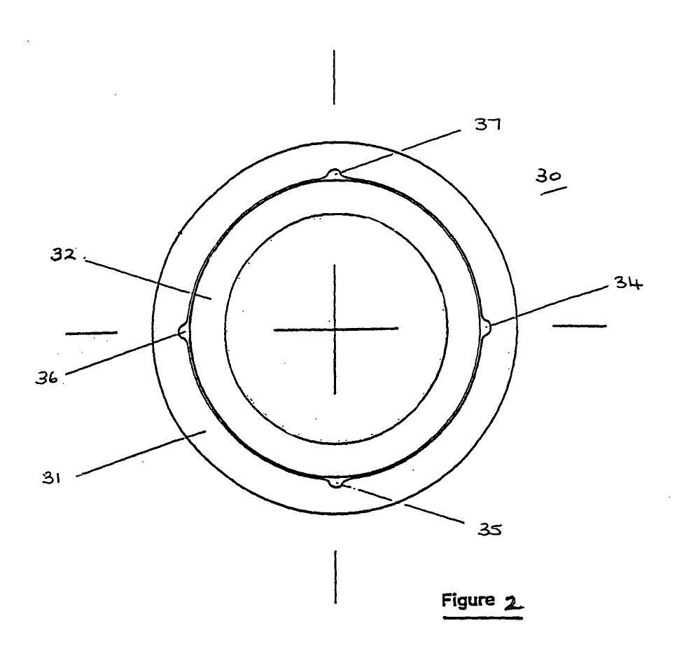

It is envisaged that this new pipe assembly will be used in a number of configurations. It could be used as a primary supply pipe alone, or within a secondary pipe of conventional construction. Alternatively, two pipe assemblies according to this invention can nest one within the other in a primary/secondary arrangement. FIG. 2 illustrates a cross-sectional view of two pipe assemblies according to the present invention nested one within the other in one such primary pipe 32 and secondary pipe 31 configuration.

In prior art pipe assemblies with secondary containment, there is usually a discreet air gap between the outer surface of the primary, inner supply pipe and the inner surface of the outer secondary pipe. As can be seen from FIG. 2, in this embodiment, there is no appreciable air gap. Any gap shown in FIG. 2 is purely for illustrative purposes only, to show that pipes 31 and 32 are separate entities and not bonded together. Rather the outer pipe assembly fits tightly and snugly over the outside of the inner supply pipe assembly. In this example the two pipes are not stuck or welded together for a number of reasons. Firstly, the pipe would be much more rigid if the inner pipe and the secondary pipe were stuck together. Improved flexibility, rather than rigidity, is a preferred feature because the complete pipe has to pass around tightly radiused bends during installation and replacement.

Secondly, the almost imperceptible gap between the two layers is permeable to fluid and forms an interstitial space between the two pipes to enable monitoring and testing to take place. This interstitial space is infinitesimally thin and difficult to measure. Nonetheless it is fluid permeable.

This interstitial space is supplemented by one or more grooves 34, 35, 36, 37 or channels formed in the inner-surface of the outer secondary pipe. These grooves or channels run the length of the pipe. They may be substantially straight, following the longitudinal axis of the pipe, or they may be spiral, helicoidal or otherwise curvilinear. The grooves do not penetrate through the inner layer of the secondary pipe. The thickness of the inner barrier layer is either greater than the depth of the grooves or the inner layer deviates around the groove profile.

The number, shape and configuration of these grooves is variable within certain limits. One groove around the circumference may be sufficient but more normally three or four grooves are formed, spaced equally around the inner circumference of the secondary pipe. A groove with a gently radiused profile, as shown in FIG. 2, is preferred since this limits any weakness in the secondary pipe which would otherwise result from the presence of grooves.

It will be appreciated that with the exception of the grooved region(s), the inner surface of the secondary pipe assembly follows substantially exactly the contour of the inner supply pipe assembly. The two pipes are thus as one, and as such, this arrangement could be considered unitary construction.

This form of construction has an additional advantage in that the outer or secondary pipe supports the primary pipe when it is under pressure, and vice versa. Thus the thickness of the primary and secondary pipe walls may be reduced for the equivalent strength of pipe compared to pipe combinations having separate primary and secondary pipes with a discrete interstitial space.

A pipe as shown in FIG. 2 can be formed using conventional extrusion techniques. It will be appreciated that this form of construction has inherent strength and flexibility. As a result, the thickness of the two pipes may be considerably less than in a conventional pipe.

The relative thickness of the various layers in the pipe assembly will vary according to the particular application. The example given below is for the case where petroleum products such as automotive or aviation fuels are to be conveyed by the pipe.

### EXAMPLE 1

If the primary pipe were 32 mm in diameter, the construction would be typically:
Inner, fluoropolymer: e.g. modified PVDF=0.3 mm
Bulk layer: e.g. PA12=0.3 mm
Outer layer: e.g. modified PVDF=2.5 mm

The secondary would be an exact copy of this, fitting snugly on top, or could be a monolayer of fluoropolymer.

### EXAMPLE 2

In this example, assuming a pipe diameter of 32 mm, the outer fluorinated layer is formed by fluorination of polyethylene. The construction would typically be:—
an inner fluoropolymer barrier layer of modified PVDF=0.3 mm;
an intermediate core layer of polyethylene=2.7 mm, the outer surface of which is fluorinated as described above.

### EXAMPLE 3

Corresponds to Example 2 with a tie layer between the PVDF layer and the PE layer. The construction of this type would typically be:—
an inner, fluoropolymer barrier layer of PVDF—0.3 mm
a tie layer e.g. Adheflon from AtoFina—0.1 mm
an intermediate, core layer of polyethylene=2.7 mm, the outer surface of which is fluorinated as described above.

### EXAMPLE 4

| | |
|---|---|
| PVDF | 0.3 mm |
| tie layer | 0.1 mm |
| PA 12 | 1.3 mm |
| tie layer | 0.1 mm |
| PVDF | 1.5 mm |

1. A flexible multi-layer pipe assembly comprising, in a radial direction from the inside to the outside:—
(i) an inner barrier layer formed from a first fluoropolymer;
(ii) an intermediate or core layer formed from a polymer or blend of polymers;
(iii) an outer barrier layer formed from a second fluoropolymer.

2. A flexible multi-layer pipe assembly as claimed in claim 1 wherein the first and second fluoropolymer layers comprise a plastics material selected from the group comprising:—
polyvinylidene fluoride (PVDF) and copolymers;
polyvinyl fluoride (PVF);
tetrafluoroethylene-ethylene copolymer (ETFE);
tetrafluoroethylene-hexafluroethylene copolymers (FEP)
ethylene tetrafluoroethylene hexafluropropylene terpolymers (EFEP)
terpolymers of tetrafluoroethylene, hexafluoropropylene and vinylidene fluoride (THV);
polyhexafluoropropylene;
polytetrafluoroethylene (PTFE);
polychlorotrifluoroethylene;
polychlorotrifluoroethylene (PCTFE);
fluorinated polyethylene;
fluorinated polypropylene,
and blends and co-polymers thereof.

3. A flexible multi-layer pipe assembly as claimed in claim 1 or claim 2 wherein the intermediate or core layer comprises a plastics material selected from the group comprising:—
polyethylene;
polypropylene;
polyvinyl chloride;
polyurethanes;
polyamides, including polyamides 6, 6.6, 6.10, 6.12, 11 and 12;
polyethylene terphthalate;
polybutylene terephthalate;
polyphenylene sulphide;
polyoxymethylene (acetal)
ethylene/vinyl alcohol copolymers,
including blends and co-polymers thereof.

4. A flexible multi-layer pipe assembly as claimed in any preceding claim wherein the outer barrier layer is an electrofusible polymer.

5. A flexible multi-layer pipe assembly as claimed in any preceding claim wherein the first fluoropolymer of the inner barrier layer incorporates a dispersed electrically conductive material producing a maximum surface resistivity of than 10⁶ Ω/sq.

6. A flexible multi-layer pipe assembly as claimed in claim 5 wherein the electrically conductive material is carbon black.

7. A flexible multi-layer pipe assembly as claimed in claim 5 wherein the electrically conductive material comprises finely powdered metallic fibres such as silver, copper or steel.

8. A flexible multi-layer pipe assembly as claimed in any preceding claims, wherein said assembly incorporates one or more tie or adhesive layer between adjacent layers (i) and (ii) and/or (ii) and (iii).

9. A flexible multi-layer pipe assembly as claimed in any preceding claim wherein the permeability of the pipe assembly to the fluid contained within the pipe is in the range 0.01 to 1 gms/m²/day.

10. A flexible multi-layer pipe assembly as claimed in claim 9 wherein the permeability is in the range 0 to 0.1 gms/m²/day.

11. A flexible multi-layer pipe assembly substantially as herein described with reference to and as illustrated in any combination of the accompanying drawings.
